(19) United States
(12) Patent Application Publication
(10) Pub. No.: US 2024/0078946 A1
(43) Pub. Date: Mar. 7, 2024

(54) Display Pipeline Compensation for a Proximity Sensor Behind Display Panel

(71) Applicant: Apple Inc., Cupertino, CA (US)

(72) Inventors: Peter F. Holland, Los Gatos, CA (US); Mahesh B. Chappalli, San Jose, CA (US)

(21) Appl. No.: 18/101,441

(22) Filed: Jan. 25, 2023

Related U.S. Application Data
(60) Provisional application No. 63/403,600, filed on Sep. 2, 2022.

(51) Int. Cl. G09G 3/20

(52) U.S. Cl. CPC G09G 3/20; G09G 2300/0819; G09G 2320/0257; G09G 2320/0285; G09G 2360/16

(57) ABSTRACT

This disclosure provide various techniques for reducing the impact of an under-display sensor on an electronic display. Some sensors (e.g., a proximity sensor), when activated, may emit a beam through the electronic display. Emitting the beam through the electronic display may cause pixels to display a different brightness level than intended. To address this, an electronic device may use spatially weighted statistics to determine a timing profile for the under-display sensor to reduce the sensor's interference on the pixels. Additionally, a compensation voltage may be applied to further reduce or eliminate the impacts of the interference.

### CROSS-REFERENCE TO RELATED APPLICATIONS

This application claims priority to U.S. Provisional Application No. 63/403,600, filed Sep. 2, 2022, entitled “Display Pipeline Compensation for a Proximity Sensor Behind Display Panel,” the disclosure of which is incorporated by reference in its entirety for all purposes.

### BACKGROUND

This disclosure relates to systems and methods for reducing or eliminating front-of-screen (FoS) artifacts due to operation of an under-display sensor of an electronic display.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (μLEDs). By causing different display pixels to emit different amounts of light, individual display pixels of an electronic display may collectively produce images.

If an electronic device includes a sensor disposed under the electronic display (e.g., to reduce the size of a bezel of the electronic display), the operation of the sensor could disrupt the operation of the electronic display, or vice versa. Some sensors (e.g., a proximity sensor), when activated, may emit a signal (e.g., beam) through the electronic display. Emitting the signal through the electronic display may, depending at least on the timing of activation of the sensor, interfere with the operation of one or more pixels of the electronic display, causing the one or more pixels to display a brightness different than what was intended. Such interferences may result in front-of-screen (FoS) artifacts, which may negatively impact user experience. Likewise, the operation of the sensor may be impacted by the programming of the electronic display. For example, the signal through the electronic display may be affected by electromagnetic interference from the electronic display based on the operation of the electronic display.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

An electronic device that has a sensor disposed under the electronic display may reduce or eliminate front-of-screen artifacts by coordinating the timing of the display or sensor to reduce interference or by determining a compensation signal to offset the interaction between these subsystems. For example, an electronic device may determine (e.g., via a processor, a controller, and so on) a timing profile for the under-display sensor based at least partially on spatially weighted statistics (SWS), such that the under-display sensor may activate (e.g., emit a beam) at a time in which interference on the pixels of the display may be reduced or eliminated.

However, in some cases, the under-display sensor may cause some interference (e.g., voltage drop or voltage rise on display pixels) even when a timing profile is applied. In some embodiments, mitigation techniques may be used to reduce or eliminate the impacts of the interference. For example, if, after activating the under-display sensor based on the timing profile, a voltage error is determined for a previous frame or subframe, a compensation signal (e.g., a voltage of opposite polarity and similar or identical magnitude) may be applied to the next frame or subframe, such that the errors average out and the FoS impact of the interference is reduced or eliminated.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device having an electronic display, in accordance with an embodiment;

FIG. 2 is an example of the electronic device in the form of a handheld device, in accordance with an embodiment;

FIG. 3 is an example of the electronic device in the form of a tablet device, in accordance with an embodiment;

FIG. 4 is an example of the electronic device in the form of a notebook computer, in accordance with an embodiment;

FIG. 5 is an example of the electronic device in the form of a wearable device, in accordance with an embodiment;

FIG. 6 is an example of the electronic device in the form of a desktop computer, in accordance with an embodiment;

FIG. 7 is a block diagram of a display pixel array of the electronic display of FIG. 1, in accordance with an embodiment;

FIG. 8 is a flowchart of a method for performing a spatially weighted statistics (SWS) analysis for an under-display sensor and applying a pixel compensation for residual voltage error on one or more display pixels caused by operation of the under-display sensor, in accordance with an embodiment;

FIG. 9 is a block diagram illustrating an under-display sensor, in accordance with an embodiment;

FIG. 10 is a flow diagram illustrating the collection of SWS, in accordance with an embodiment;

FIG. 11 is a diagram illustrating the operation of the SWS collection circuitry and the under-display sensor with respect to time, in accordance with an embodiment;

FIG. 12 is a flow diagram for determining a timing profile for the under-display sensor, in accordance with an embodiment; and

FIG. 13 is a flow diagram for residual error mitigation performed by residual error mitigation circuitry, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

To reduce the size of a bezel around the electronic display, a sensor may be disposed beneath a display panel of the electronic display. In some embodiments, the sensor may be coupled to or disposed near a laser. For example, a proximity sensor may emit a beam at a nearby object (e.g., a user of the electronic device). The proximity sensor may receive the reflection of the emitted beam to determine the distance between the proximity sensor (e.g., and therefore the electronic device) and the nearby object.

However, in some cases, the operation of the sensor (e.g., the emission of the beam) may produce undesirable effects in the electronic device. Continuing with the previous example, if the proximity sensor fires an emission during certain operations of the electronic devices (e.g., programming image data into pixels of the electronic device) the emission may cause undesirable effects (e.g., front of screen (FoS) artifacts) by inducing a voltage on the pixels being programmed, causing distortion at the pixel that may cause the pixel to output a different color or brightness than was intended by the image data, which may negatively impact user experience.

To mitigate undesirable outcomes such as FoS artifacts, spatially weighted statistics (SWS) may be gathered to determine a more favorable or optimized emission timing profile to cause the sensor to operate during times when the undesirable outcomes may be mitigated or eliminated. However, in some situations, analyzing the SWS may still result in operation of the sensor that causes some, albeit reduced, interference or distortion on the electronic display. For example, using SWS to determine a timing profile for the operation of a proximity sensor may result in a smaller residual induced voltage (e.g., and thus a smaller voltage error) on the pixels of the electronic display, and the smaller induced voltage may lead to undesirable FoS artifacts. To address this, compensation techniques may be used to offset the residual voltage error. In some embodiments, a processor or controller of the electronic device may determine the residual voltage error experienced on the electronic display during a first frame and adjust the data on a subsequent second frame to offset the residual voltage error on the first frame. For example, if a processor determines that the operation of a sub-display sensor causes a voltage error of 10 millivolt (mV) on a row of pixels during a first frame, the processor may adjust the image data for the subsequent frame such that the voltage on the same row of pixels has a −10 mV offset. Consequently, the voltage error may average out and the residual FoS artifacts may be further reduced or eliminated.

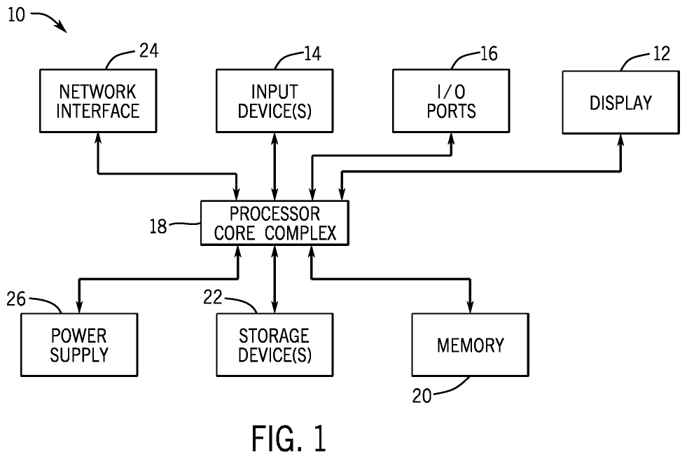

With this in mind, an example of an electronic device 10, which includes an electronic display 12 that may benefit from these features, is shown in FIG. 1. FIG. 1 is a schematic block diagram of the electronic device 10. The electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a wearable device, a watch, a vehicle dashboard, and/or the like. Thus, it should be noted that FIG. 1 is merely one example of a particular implementation and is intended to illustrate the types of components that may be present in an electronic device 10.

In addition to the electronic display 12, as depicted, the electronic device 10 includes one or more input devices 14, one or more input/output (I/O) ports 16, a processor core complex 18 having one or more processors or processor cores and/or image processing circuitry, memory 20, one or more storage devices 22, a network interface 24, and a power supply 26. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the memory 20 and the storage devices 22 may be included in a single component. Additionally or alternatively, image processing circuitry of the processor core complex 18 may be disposed as a separate module or may be disposed within the electronic display 12.

The processor core complex 18 is operably coupled with the memory 20 and the storage device 22. As such, the processor core complex 18 may execute instructions stored in memory 20 and/or a storage device 22 to perform operations, such as generating or processing image data. The processor core complex 18 may include one or more microprocessors, one or more application specific processors (ASICs), one or more field programmable logic arrays (FPGAs), or any combination thereof.

In addition to instructions, the memory 20 and/or the storage device 22 may store data, such as image data. Thus, the memory 20 and/or the storage device 22 may include one or more tangible, non-transitory, computer-readable media that store instructions executable by processing circuitry, such as the processor core complex 18, and/or data to be processed by the processing circuitry. For example, the memory 20 may include random access memory (RAM) and the storage device 22 may include read only memory (ROM), rewritable non-volatile memory, such as flash memory, hard drives, optical discs, and/or the like.

The network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a fourth-generation wireless network (4G), LTE, or fifth-generation wireless network (5G), or the like. In other words, the network interface 24 may enable the electronic device 10 to transmit data (e.g., image data) to a communication network and/or receive data from the communication network.

The power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter. A power management integrated circuit (PMIC) may control the provision and generation of electrical power to the various components of the electronic device 10.

The I/O ports 16 may enable the electronic device 10 to interface with another electronic device 10. For example, a portable storage device may be connected to an I/O port 16, thereby enabling the electronic device 10 to communicate data, such as image data, with the portable storage device.

The input devices 14 may enable a user to interact with the electronic device 10. For example, the input devices 14 may include one or more buttons, one or more keyboards, one or more mice, one or more trackpads, and/or the like. Additionally, the input devices 14 may include touch sensing components implemented in the electronic display 12, as described further herein. The touch sensing components may receive user inputs by detecting occurrence and/or position of an object contacting the display surface of the electronic display 12.

In addition to enabling user inputs, the electronic display 12 may provide visual representations of information by displaying one or more images (e.g., image frames or pictures). For example, the electronic display 12 may display a graphical user interface (GUI) of an operating system, an application interface, text, a still image, or video content. To facilitate displaying images, the electronic display 12 may include a display panel with one or more display pixels. The display pixels may represent sub-pixels that each control a luminance of one color component (e.g., red, green, or blue for a red-green-blue (RGB) pixel arrangement).

The electronic display 12 may display an image by controlling the luminance of its display pixels based at least in part image data associated with corresponding image pixels in image data. In some embodiments, the image data may be generated by an image source, such as the processor core complex 18, a graphics processing unit (GPU), an image sensor, and/or memory 20 or storage devices 22. Additionally, in some embodiments, image data may be received from another electronic device 10, for example, via the network interface 24 and/or an I/O port 16.

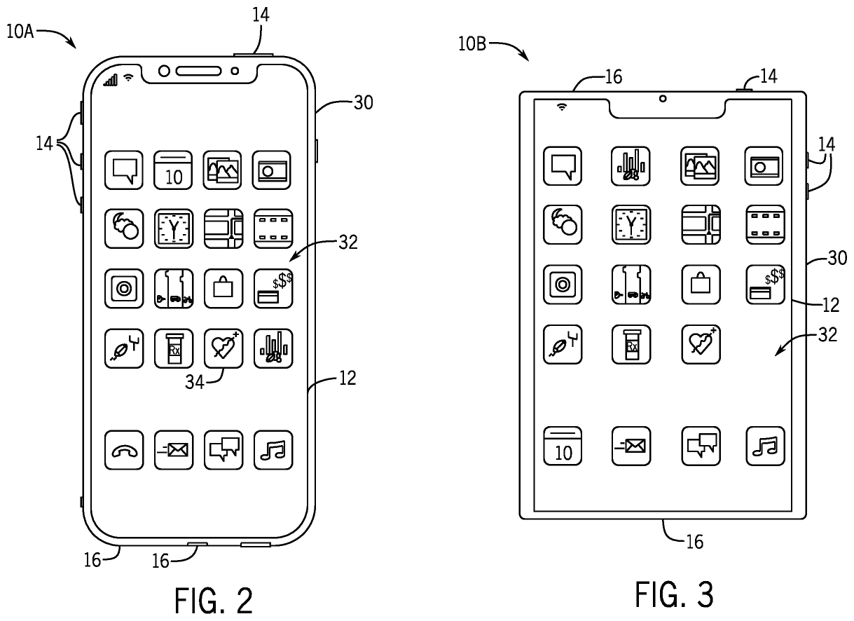

One example of the electronic device 10, specifically a handheld device 10A, is shown in FIG. 2. FIG. 2 is a front view of the handheld device 10A representing an example of the electronic device 10. The handheld device 10A may be a portable phone, a media player, a personal data organizer, a handheld game platform, and/or the like. For example, the handheld device 10A may be a smart phone, such as any iPhone® model available from Apple Inc.

The handheld device 10A includes an enclosure 30 (e.g., housing). The enclosure 30 may protect interior components from physical damage and/or shield them from electromagnetic interference. In the depicted embodiment, the electronic display 12 is displaying a graphical user interface (GUI) 32 having an array of icons 34. By way of example, when an icon 34 is selected either by an input device 14 or a touch sensing component of the electronic display 12, an application program may launch.

Input devices 14 may be provided through the enclosure 30. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. The I/O ports 16 also open through the enclosure 30. The I/O ports 16 may include, for example, a Lightning® or Universal Serial Bus (USB) port.

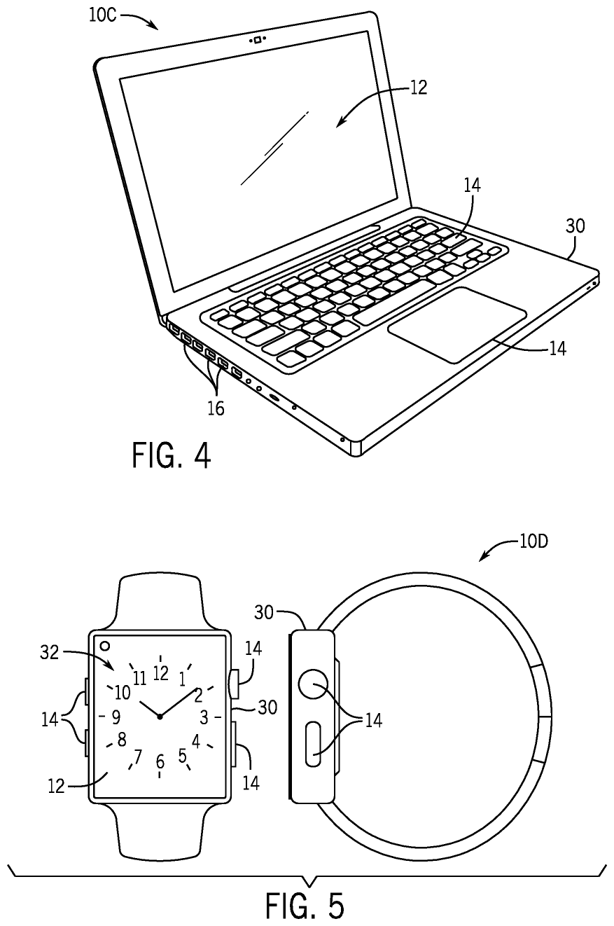

The electronic device 10 may take the form of a tablet device 10B, as shown in FIG. 3. FIG. 3 is a front view of the tablet device 10B representing an example of the electronic device 10. By way of example, the tablet device 10B may be any iPad® model available from Apple Inc. A further example of a suitable electronic device 10, specifically a computer 10C, is shown in FIG. 4. FIG. 4 is a front view of the computer 10C representing an example of the electronic device 10. By way of example, the computer 10C may be any MacBook® or iMac® model available from Apple Inc. Another example of a suitable electronic device 10, specifically a watch 10D, is shown in FIG. 5. FIG. 5 are front and side views of the watch 10D representing an example of the electronic device. By way of example, the watch 10D may be any Apple Watch® model available from Apple Inc. As depicted, the tablet device 10B, the computer 10C, and the watch 10D all include respective electronic displays 12, input devices 14, I/O ports 16, and enclosures 30.

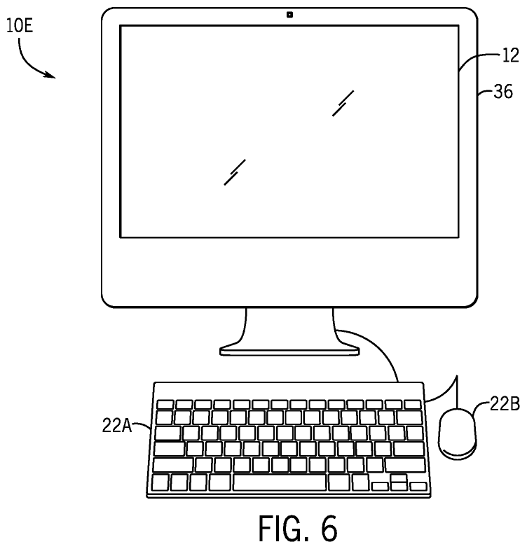

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 36 may be provided to protect and enclose internal components of the computer 10E, such as the display 12. In certain embodiments, a user of the computer 10E may interact with the computer 10E using various peripheral input structures 22, such as the keyboard 22A or mouse 22B (e.g., input structures 22), which may connect to the computer 10E.

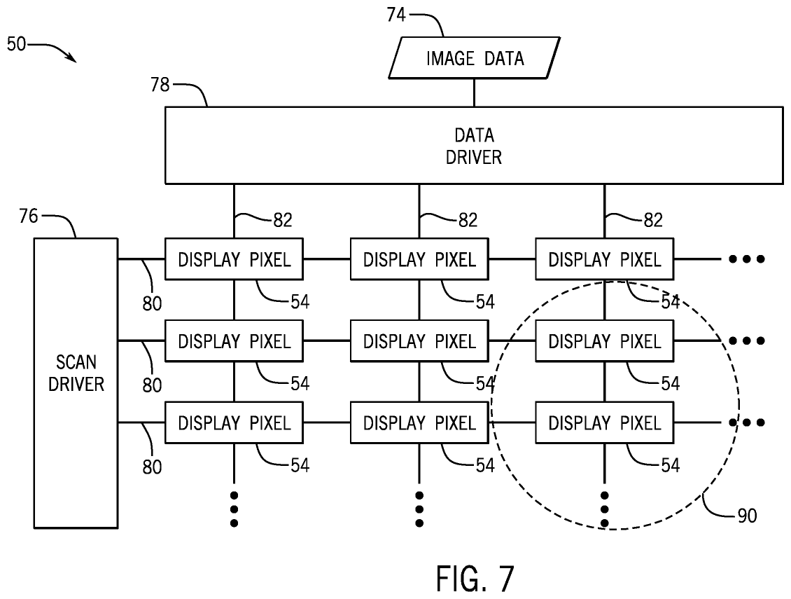

FIG. 7 is a block diagram of a display pixel array 50 of the electronic display 12. It should be understood that, in an actual implementation, additional or fewer components may be included in the display pixel array 50. The electronic display 12 may receive any suitable image data for presentation on the electronic display 12. The electronic display 12 includes display driver circuitry that includes scan driver circuitry 76 and data driver circuitry 78. The display driver circuitry controls programing the image data 74 into the display pixels 54 for presentation of an image frame via light emitted according to each respective bit of image data 74 programmed into one or more of the display pixels 54.

The display pixels 54 may each include one or more self-emissive elements, such as a light-emitting diodes (LEDs) (e.g., organic light emitting diodes (OLEDs) or micro-LEDs (μLEDs)); however, other pixels may be used with the systems and methods described herein including but not limited to liquid-crystal devices (LCDs), digital mirror devices (DMD), or the like. Different display pixels 54 may emit different colors. For example, some of the display pixels 54 may emit red light, some may emit green light, and some may emit blue light. Thus, the display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use red (R), green (G), blue (B), or others.

The scan driver circuitry 76 may provide scan signals (e.g., pixel reset, data enable, on-bias stress, emission (EM)) on scan lines 80 to control the display pixels 54 by row. For example, the scan driver circuitry 76 may cause a row of the display pixels 54 to become enabled to receive a portion of the image data 74 from data lines 82 from the data driver circuitry 78. In this way, an image frame of the compensated image data 74 may be programmed onto the display pixels 54 row by row. Other examples of the electronic display 12 may program the display pixels 54 in groups other than by row. When the scan driver circuitry 76 provides an emission signal to certain pixels 54, those pixels 54 may emit light according to the image data 74 with which those pixels 54 were programmed.

As previously stated, in some scenarios, a sensor may be disposed beneath a display panel of the electronic display 12 (e.g., to reduce a bezel size of the electronic display 12). In some embodiments, an under-display sensor 90 may emit a beam when activated. For example, a proximity sensor may emit a beam at a nearby object (e.g., a user of the electronic device 10). The proximity sensor may receive the reflection of the emitted beam to determine the distance between the proximity sensor (e.g., and therefore the electronic device 10) and the nearby object. As another example, the under-display sensor 90 may include a fingerprint scanner, a thermal sensor, an ambient light sensor, and so on.

However, in some cases, the activation of the under-display sensor 90 (e.g., the emission of the beam) may produce undesirable effects in the electronic device 10. For example, if the under-display sensor 90 fires an emission during certain operations of the electronic device 10 (e.g., programming the image data 74 into the display pixels 54 of the electronic device 10) the emission may cause undesirable effects (e.g., front of screen (FoS) artifacts) by inducing a voltage on the display pixels 54 being programmed, causing distortion at the display pixels 54 that may cause the display pixels 54 to output a color or brightness that does not correspond to the image data 74. To mitigate undesirable outcomes such as FoS artifacts, spatially weighted statistics may be gathered to determine a more favorable or optimized emission timing profile to cause the under-display sensor 90 to operate during times when the undesirable outcomes may be mitigated or eliminated.

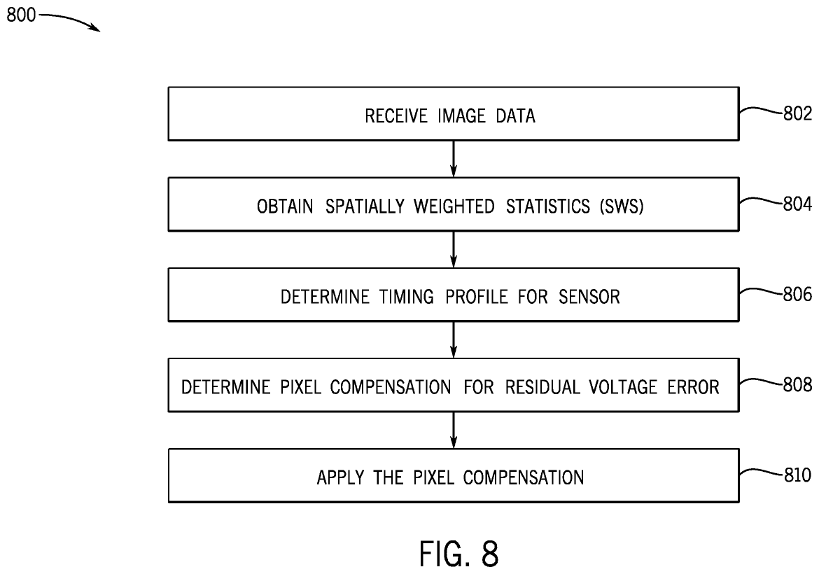

FIG. 8 is a flowchart of a method 800 for performing a spatially weighted statistics analysis for an under-display sensor and applying a pixel compensation for residual voltage error on one or more display pixels 54 caused by operation of the under-display sensor. Any suitable device (e.g., a controller) that may control components of the electronic device 10, such as the processor core complex 18, may perform the method 800. In some embodiments, the method 800 may be implemented by executing instructions stored in a tangible, non-transitory, computer-readable medium, such as the memory 20 or storage devices 22, using the processor core complex 18. For example, the method 800 may be performed at least in part by one or more software components, such as an operating system of the electronic device 10, one or more software applications of the electronic device 10, and the like. While the method 800 is described using steps in a specific sequence, it should be understood that the present disclosure contemplates that the described steps may be performed in different sequences than the sequence illustrated, and certain described steps may be skipped or not performed altogether.

In process block 802 of the method 800, the processor core complex 18 receives the image data 74. The image data 74 may include image data corresponding to a current frame or a previous frame or subframe of content to be displayed on the electronic display 12. In process block 804, the processor core complex 18 may obtain spatially weighted statistics (SWS). The processor core complex 18 (or other circuitry that may be used in determining SWS) may collect statistics (e.g., histogram statistics) on red, green, and blue (RGB) color values of the image data 74 to determine enhanced or optimized timing for activation of an under-display sensor. The processor core complex 18 may collect statistics (e.g., histogram statistics) on a luma (Y) value, the Y value representing a weighted combination of the RGB color values.

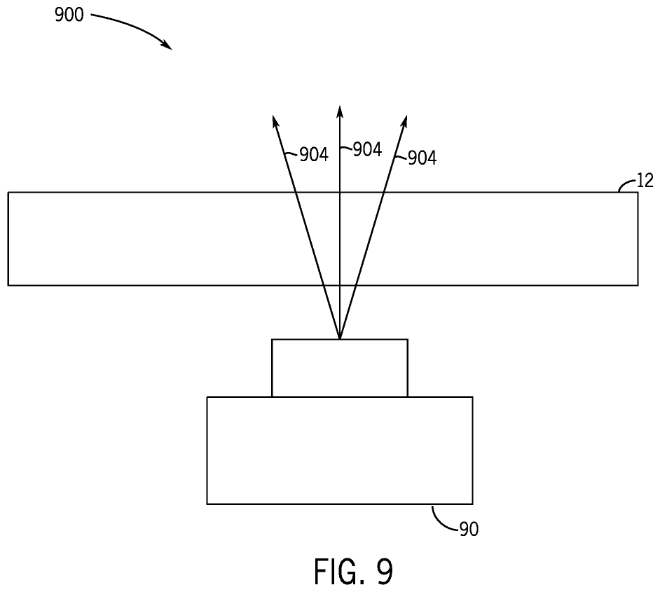

In process block 806, the processor core complex 18 determines a timing profile for the under-display sensor. FIG. 9 is a block diagram 900 illustrating an under-display sensor 90. The under-display sensor 90 may emit one or more beams 904 through the electronic display 12. As will be discussed in greater detail below, the under-display sensor 90 may reduce or exacerbate distortion on the display pixels 54 of the electronic display 12 based on when the under-display sensor 90 emits the beams 904. For example, if the under-display sensor 90 emits the beams 904 during programming of the display pixels 54, the beams 904 may induce a voltage on the display pixels 54, causing distortion on the display pixels 54 and thus causing the display pixels to be brighter (e.g., due to an induced positive voltage) or darker (e.g., due to an induced negative voltage) than intended. In some embodiments, the under-display sensor 90 may include a proximity sensor that may emit the beams 904 at a nearby object (e.g., a user of the electronic device). The proximity sensor may receive the reflection of the emitted beam to determine a distance between the under-display sensor 90 (e.g., and therefore the electronic device 10) and the nearby object.

Returning to FIG. 8, in the process block 806, the processor core complex 18 may, after determining the timing profile based on the SWS, cause the under-display sensor 90 to activate and/or deactivate (e.g., emit or refrain from emitting the beams 904) according to the determined timing profile. Despite adjusting the activation timing of the under-display sensor 90 based on the timing profile, emitting the beams 904 may still cause some residual voltage error on the display pixels 54. In process block 808, the processor core complex 18 may determine a pixel compensation to mitigate the voltage error induced by activating the under-display sensor 90. The pixel compensation may include a compensation signal such as a compensation voltage. For example, if the processor core complex 18 determines that a previous subframe (e.g., a subframe N) of content displayed on the electronic display 12 was associated with a 10 mV voltage droop (e.g., a voltage error of −10 mV) on a particular row of the display pixels 54, the processor core complex 18 may determine a +10 mV voltage compensation for a current subframe (e.g., a subframe N+1). In some embodiments, the processor core complex 18 may apply the compensation signal to the display pixels 54 corresponding to an entire frame or subframe. In other embodiments, the processor core complex 18 may apply the compensation signal for a row being programmed at the time of operation of the under-display sensor 90.

In process block 810, the processor core complex 18 may apply the pixel compensation determined in the process block 808. Continuing with the previous example, the processor core complex 18 may apply the +10 mV voltage compensation (e.g., a voltage error of +10 mV) to the image data 74 corresponding to the current subframe. Consequently, the voltage errors of the previous subframe and the current subframe may average out, reducing or eliminating the FoS impact of the voltage error on the previous subframe. While the method 800 is described as being performed by the processor core complex 18 (e.g., software executed by the processor core complex 18), it should be noted that the method 800 may be performed by dedicated physical hardware, physical hardware components implementing software instructions or software modules or components, or any combination thereof.

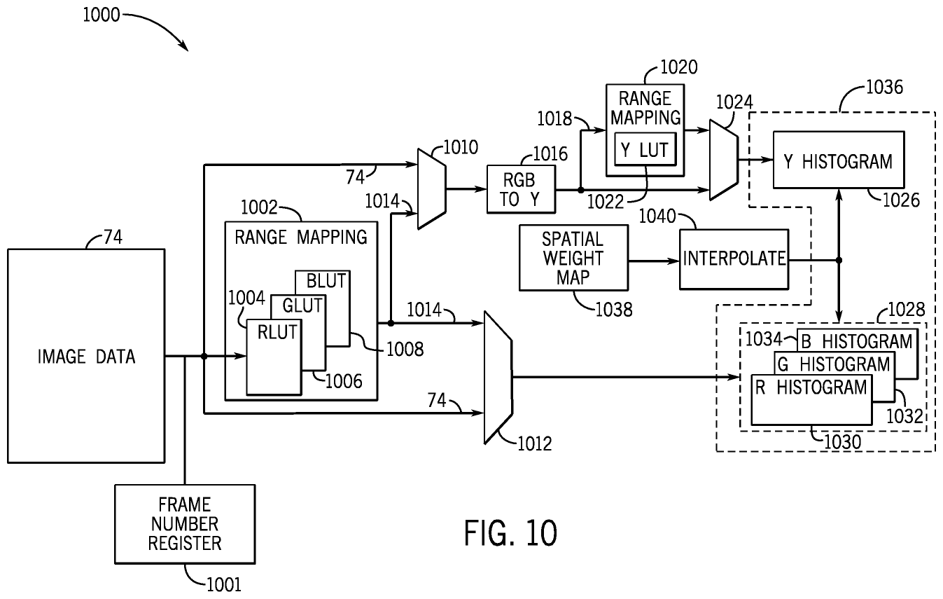

FIG. 10 is a flow diagram illustrating the collection of spatially weighted statistics (SWS) as discussed with respect to the process block 804 of FIG. 8. The SWS collection circuitry 1000 may collect histogram statistics on RGB image data values and Y values to determine an enhanced or optimized timing for activation of the under-display sensor 90. The SWS collection circuitry 1000 may receive the image data 74 corresponding to a particular frame. A frame number corresponding to the determined SWS 1036 may be captured in a frame number register 1001. Multiple sets of SWS 1036 (e.g., two or more sets, three or more sets, five or more sets, and so on) may be collected. At the beginning of a new frame where SWS collection is enabled, a set may be selected (e.g., by the processor core complex 18). The selected set of SWS 1036 may be cleared and repopulated (e.g., by SWS collected for an incoming frame). If SWS collection is disabled, the sets of histogram statistics may not be cleared at the beginning of the frame. In other words, the SWS sets that are not selected may not be cleared, and thus may retain the values collected from the previous frame.

A region of the electronic display 12 may be determined as an active region for gathering the SWS 1036. Display pixels 54 in the active region may contribute to the collected SWS 1036. The active region may be defined in terms of start coordinates along each dimension and a size relative to the start coordinate along each dimension. An active region may have dimensions ranging from 25×25 to 100×100, and may be entirely included within a given frame. The active region may be selected based on the position of the pixels in the active region in relation to the under-display sensor 90. For example, pixels that are directly above the under-display sensor 90 or pixels on a row directly above the under-display sensor 90 may be most likely to be affected by the under-display sensor 90, and thus may be included in the selected active region.

In some embodiments, the image data 74 may be sent to range mapping circuitry 1002. In other embodiments, the range mapping circuitry 1002 may be bypassed and the image data 74 may be sent directly to selection circuitry 1010 (e.g., a multiplexer) and selection circuitry 1012 (e.g., a multiplexer). Performing range mapping via the range mapping circuitry 1002 may provide higher precisions for certain intensity levels of the image data 74 when the histogram statistics are collected. For example, applying a gamma curve prior to collecting the SWS 1036 may provide a greater number of samples for dark intensities. The range mapping circuitry 1002 may use a separate one-dimensional lookup table (1D LUT) for 1004, 1006, and 1008 for the red, green, and blue color components, respectively.

Independent histograms (e.g., R histogram 1030, G histogram 1032, and B histogram 1034) may be generated for the red, green, and blue (RGB) color values. The spacing of histogram bins may be determined from settings in a histogram bin spacing register and may be adjusted independently for the red, blue, and green color values and the Y value 1018. In one example, the histograms may be equally spaced or non-equally spaced with 65 bins spanning the range [0, 212-1]. The RGB color values used for the determination of the R histogram 1030, the G histogram 1032, and/or the B histogram 1034 may be based on the RGB values at the input of the range mapping circuitry 1002 (e.g., the RGB values of the image data 74) or the output (e.g., 1014) of the range mapping circuitry 1002.

As previously stated, a luma (Y) value 1018 may represent a weighted combination of the RGB color values. In Y-derivation circuitry 1016, a Y histogram 1026 may be populated based on the Y value 1018 that is determined as a weighted combination of the RGB color values. The RGB values used for the determination of the Y histogram 1026 may be the RGB values at the input (e.g., the image data 74) or the output (e.g., 1014) of the range mapping circuitry 1002. Similar to the RGB color values, the determined Y value 1018 may go through range mapping (e.g., in the Y-derivation range mapping circuitry 1020) such that certain intensity levels may have high precision when the SWS 1036 are collected.

The Y-derivation range mapping circuitry 1018 may use a 1D LUT (Y LUT 1022) for the Y component. When the Y value 1018 has a range [0, 212-1], 257 entries of the Y LUT 1022 cover the range [0, 212]. When input value falls between intervals, the output values may be linearly interpolated. The result may then be clamped to the range [0, 212-1]. When range mapping is bypassed for Y (e.g., such that the Y value 1018 is sent directly to an input of selection circuitry 1024) and it has values in the range [0, 222-1], the value may be right-shifted by 10 prior to collection of the Y histogram 1026.

As the FoS artifact (e.g., a local contrast artifact) induced by the beams 904 may vary spatially, the collected SWS 1036 that aid in determining the timing profile for activating the under-display sensor 90 may be weighted based on a spatial position of the display pixel(s) 54 within the active region of the SWS collection circuitry 1000. This weighting may be achieved by use of a programmed map of weight values stored in spatial weight map circuitry 1038. For example, the spatial weight map may provide a greatest weighting factor for display pixels 54 disposed directly above the under-display sensor 90 and may provide decreasing weighting factors as the spatial position of the display pixles 54 increase in distance from the under-display sensor 90. In some embodiments, the weight values may be interpolated by the interpolation circuitry 1040.

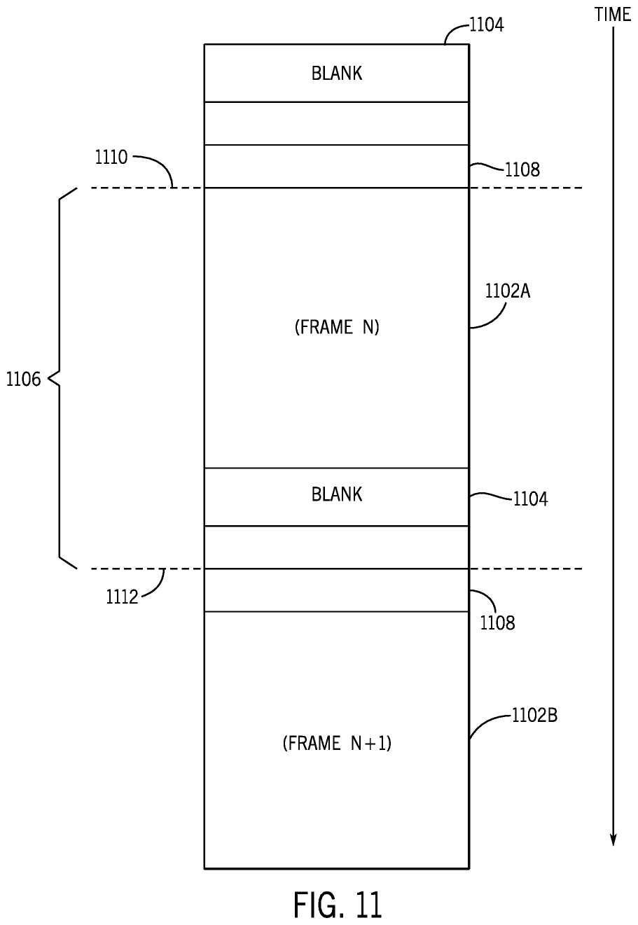

FIG. 11 is a diagram illustrating the operation of the SWS collection circuitry 1000 and the under-display sensor 90 with respect to time. The processor core complex 18 may transmit an activation signal to trigger the under-display sensor 90, causing the under-display sensor 90 to emit the beams 904. The under-display sensor 90 may, during some situations (e.g., in an idle mode) be running on a slow clock signal to conserve power. An assertion of the activation signal may cause the under-display sensor 90 to begin running on a fast clock signal. In some embodiments, deassertion of the activation signal may cause the under-display sensor 90 to emit the beams 904. For example, if the under-display sensor 90 is a proximity sensor, an assertion of the activation signal may be triggered by a phone call, causing the under-display sensor 90 to begin operating on the fast clocks, as it may be desired for the proximity sensor to be active to determine when the electronic device 10 is near a user. A deassertion of the activation signal may cause the proximity sensor to emit a beam to measure the distance to the user and return to the idle mode (e.g., running on the slow clocks).

The active region 1102 may represent the electronic display 12 or a portion of the electronic display 12 which displays content during a given frame or subframe. The blanking regions 1104 may delineate the end of the active region 1102. The activation signal may be asserted during at least a portion of the section 1106 for a previous frame N. The activation signal may be deasserted prior to the SWS collection regions 1108 to prevent the under-display sensor 90 from emitting the beams 904 while the SWS collection circuitry 1000 gathers SWS 1036 on an incoming frame N+1. For example, the timing profile for the under-display sensor 90 to emit the beams 904 may be based at least partially on frame content anticipated to be displayed in the incoming frame N+1. Anticipating when certain frame content may be displayed on the electronic display 12 may decrease the likelihood of unintentionally emitting the beams 904 during programming of the display pixels 54. In some embodiments, anticipated frame content for a current frame or incoming frame N+1 may be based at least partially on a previous frame N. Accordingly, prior to displaying the content of the frame N+1 on the electronic display 12, SWS 1036 may be collected regarding the incoming frame N+1.

The timing profile may be determined based on the SWS 1036, and may be used by the processor core complex 18 to assert and/or deassert the activation signal to cause the under-display sensor 90 to emit the beams 904 in a way that may reduce the likelihood of causing distortion (e.g., voltage error) on the display pixels 54 in the active region 1102. The activation signal may be asserted, according to the determined timing profile, at a certain time (e.g., at the time 1110 at the earliest) during the section 1106 to cause the under-display sensor to start running on the fast clocks.

Once the activation signal is asserted, it may be deasserted at any point before the time 1112 based on the determined timing profile. As previously stated, deassertion of the activation signal may cause the under-display sensor 90 to emit the beams 904. As it may be desirable to avoid emitting the beams 904 during the SWS collection regions 1108, the deassertion of the activation signal (and thus the firing of the beams 904) may occur, at the latest, at the time 1112 for the frame N. Once the frame content of the frame N leaves the electronic display 12, the SWS collection circuitry 1000 may begin collecting SWS to determine a timing profile for the frame N+1.

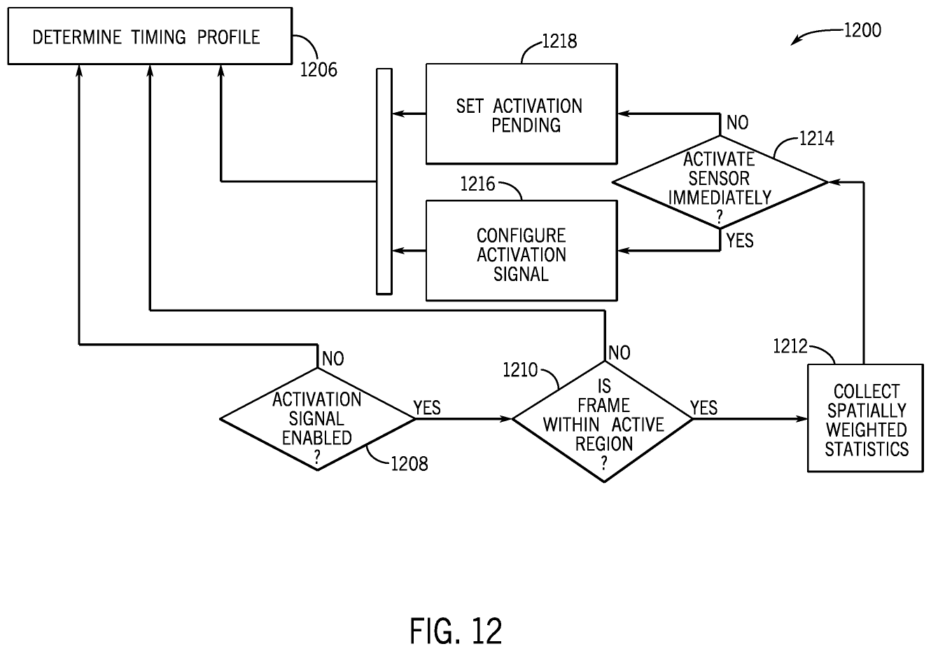

FIG. 12 is a flow diagram for determining a timing profile for the under-display sensor 90. The flow diagram may apply to any appropriate electronic display, such as an OLED display, a uLED display and so on. In query block 1208, the processor core complex 18 may determine whether the under-display sensor 90 activation signal is enabled. If the processor core complex 18 determines that the under-display sensor activation signal is not enabled, the processor core complex 18 will determine, in process block 1206, a timing profile based on the under-display activation signal being disabled. If, however, the processor core complex 18 determines that the under-display sensor activation signal is enabled, the processor core complex 18 may, in query block 1210, determine whether a relevant frame is within the active region (e.g., 1102).

If the processor core complex 18 determines that the relevant frame is not within the active region 1102, the processor core complex 18 will determine, in the process block 1206, a timing profile based on the relevant frame not being with the active region 1102. If the processor core complex 18 determines that the relevant frame is within the active region 1102, in process block 1212 the processor core complex 18 may (e.g., via the SWS collection circuitry 1000) collect relevant SWS (e.g., 1036). Based on the relevant SWS, the processor core complex 18 determines in query block 1214 whether to activate the under-display sensor 90 immediately. If, in query block 1214, the processor core complex 18 determines that the activation signal may be activated immediately, in process block 1216 the processor core complex 18 configures the activation signal. However, if the processor core complex 18 determines in query block 1214 that the activation signal may be delayed, in process block 1218 the processor core complex 18 may set an activation signal pending time. For example, setting a pending time for the activation signal may delay the deassertion of the activation signal (and thus delay the activation of the under-display sensor 90). In the process block 1206, the timing profile may be determined based on whether the activation signal was configured (e.g., in the process block 1216) or was set to pending (e.g., in the process block 1218).

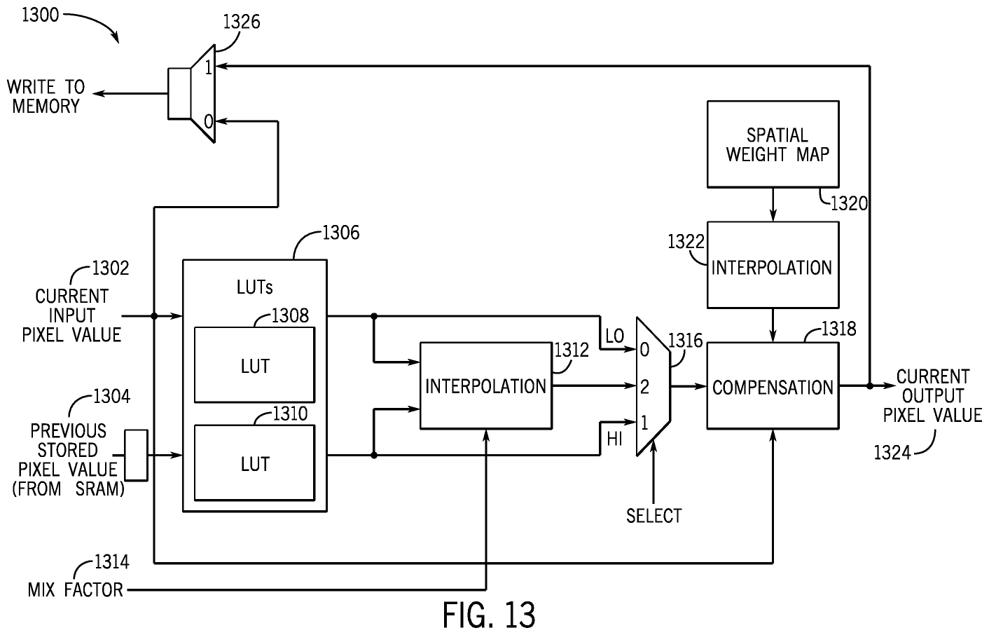

As previously discussed, in some scenarios there may remain some amount of residual error (e.g., voltage error) on the display pixels 54 after activating the under-display sensor 90 according to the timing profile. To address this issue, mitigation actions may be performed on the electronic display 12 to account and correct for the residual error. FIG. 13 is a flow diagram for residual error mitigation performed by residual error mitigation circuitry 1300. The error to be mitigated is a function of a current input pixel value 1302 (e.g., pixel values for content displayed during a frame currently being displayed on the electronic display 12), and a previous frame pixel value 1304 (e.g., a pixel value for content that was displayed during a frame previously displayed on the electronic display 12) as well as other parameters such as timing of the under-display sensor 90, brightness of the electronic display 12, refresh rate, and so on. The residual contrast to be mitigated may be modeled as a two-dimensional (2D) LUT 1306 indexed by the current frame pixel value 1302 and the previous frame pixel value 1304. The 2D LUT 1306 may include an LUT 1308, which may perform a 2D lookup based on the current frame pixel values 1302 and an LUT 1310, which may perform a 2D lookup based on the previous frame pixel values 1304.

In some embodiments, the LUT 1308 and the LUT 1310 are interpolated via interpolation circuitry 1312. The results of the interpolation of the LUT 1308 and the LUT 1310 may be combined based on a mix factor 1314. The interpolation circuitry 1312 may perform the interpolation using any appropriate interpolation algorithm (e.g., a hybrid barycentric-bilinear algorithm). The interpolation circuitry may have multiple modes that may be activated based on the relationship between the current frame pixel value 1302 and the previous frame pixel value 1304. In some embodiments, the interpolation circuitry 1312 may operate in a normal mode. In the normal mode, the interpolation circuitry 1312 may interpolate the LUTs 1306. In a first bypass mode, the interpolation may be bypassed whenever the current frame input pixel value 1302 are equal to the previous frame pixel value 1304. In a second bypass mode, the interpolation may be bypassed whenever the current frame pixel value 1302 is less than or equal to than the previous frame pixel value 1304. In a third bypass mode, interpolation may be bypassed whenever the current frame input pixel value 1302 is greater than or equal to the previous frame pixel value 1304. In a fourth bypass mode, interpolation may be bypassed whenever the absolute value of the difference of the current frame pixel values 1302 and the previous frame pixel value 1304 is less than or equal to a programmed threshold.

An FoS artifact caused by the residual error induced by operation of the under-display sensor 90 may vary spatially (e.g., based on the location of the under-display sensor 90). Due to the spatial variance, it may be beneficial for the residual error mitigation circuitry 1300 to obtain information regarding a spatial position of the FoS artifact on the electronic display 12 (e.g., by obtaining a position of the affected display pixels 54). The residual error mitigation circuitry 1300 may apply a weight to a compensation value 1318 (e.g., received from selection circuitry 1316 based on the output of the LUTs 1306 and/or the interpolation circuitry 1312) based on a spatial weighting map 1320 (e.g., a programmed map of weight values) to spatially weight the compensation value 1318. For example, a greater weighting factor may be applied to the compensation value 1318 if the affected display pixels 54 are near (e.g., directly above) the under-display sensor 90, while a lesser weighting factor may be applied to the compensation value 1318 if the affected display pixels 54 are farther from the under-display sensor 90. In some embodiments, the spatial weight outputted by the spatial weight map 1320 may be interpolated via interpolation circuitry 1322. The residual error mitigation circuitry 1300 may output a current frame output pixel value 1324 based on the compensation value 1318. For example, the residual error mitigation circuitry 1300 may apply a positive compensation value 1318 if the previous frame pixel value 1304 had a negative voltage error (e.g., resulting in a darker pixel output than was intended) or may apply a negative compensation value 1318 if the previous frame pixel value 1304 had a positive voltage error (e.g., resulting in a brighter pixel output than was intended). Accordingly, an FoS artifact may be mitigated over a number of frames by averaging out the voltage errors on the display pixels 54. It should be noted that, in addition to the current frame pixel value 1302 and the pervious frame pixel value 1304, the compensation value 1318 may be based on a timing profile as discussed above.

A defined active region may be stored in memory. For example, the defined active region may be fed into selection circuitry 1326 and stored in memory (e.g., static RAM (SRAM)) with 10-bits of accuracy for the current input pixel value 1302 and the current output pixel value 1324. The memory may be memory mapped and may be accessed by the processor core complex 18. The current frame input pixel value 1302 and/or the current frame output pixel value 1324 may be fed into selection circuitry 1326 and be stored in the memory.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
receiving image data;
determining, based on the image data, a time period during which display pixels are not programmed with image data;
activating a sensor disposed beneath an electronic display during the time period;
determining a pixel compensation to compensate for residual voltage error occurring at one or more display pixels due to activating the sensor; and
applying the pixel compensation to the one or more display pixels.

2. The method of claim 1, wherein determining the time period comprises obtaining spatially weighted statistics.

3. The method of claim 2, wherein obtaining the spatially weighted statistics comprises:
obtaining a plurality of color values from the image data;
deriving a Y value from the color values, wherein the Y value comprises a weighted combination of the color values; and
spatially weighting the plurality of color values, the Y value, or both based on a spatial position of the one or more display pixels.

4. The method of claim 3, wherein the spatially weighted statistics comprise one or more histograms based on the plurality of color values, the Y value, or both.

5. The method of claim 3, wherein the plurality of color values, the Y value, or both are spatially weighted with a greater weighting factor based on the one or more display pixels comprising a spatial position directly above the sensor.

6. The method of claim 1, wherein the sensor comprises a proximity sensor.

7. The method of claim 1, wherein the electronic display comprises an organic light-emitting diode (OLED) display, a micro light-emitting diode (μLED) display, or a liquid crystal display (LCD).

8. The method of claim 1, comprising determining the time period during which the sensor activates based on content to be displayed on the electronic display determined at least in part by image data, previously received image data, or both.

9. An electronic device, comprising:
an electronic display;
a sensor disposed beneath the electronic display, the sensor configured to emit a beam; and
processing circuitry configured to:
receive image data corresponding to first frame content corresponding to a current frame, second frame content corresponding to a previous frame, or both;
and
determine a timing profile comprising a time period during which display pixels are not programmed with image data; and
cause the sensor to emit the beam during the time period.

10. The electronic device of claim 9, wherein the processing circuitry is configured to perform range mapping on the image data, wherein performing range mapping increases precision of particular intensity levels of the image data.

11. The electronic device of claim 10, wherein the processing circuitry is configured to perform range mapping by performing range mapping on red color values, green color values, and blue color values associated with the image data.

12. The electronic device of claim 11, comprising determining statistics via the processing circuitry comprises determining a histogram corresponding to each of the red color values, the green color values, and the blue color values respectively.

13. The electronic device of claim 12, wherein determining the statistics via the processing circuitry comprises determining a histogram for a Y value, wherein the Y value comprises a weighted combination of the red color values, the green color values, and the blue color values.

14. The electronic device of claim 13, wherein the processing circuitry is configured to apply a weighting factor based on a spatial position of a plurality of display pixels of the electronic display in relation to a spatial position of the sensor.

15. A tangible, non-transitory, computer-readable medium, comprising computer-readable instructions that, when executed by one or more processors of an electronic device, cause the electronic device to:
determine a voltage error on an electronic display associated with an under-display sensor during a previous frame displayed on the electronic display;
perform, via a lookup table (LUT), a lookup based on a current frame input pixel value, a previous frame input pixel value, or both;
determine a compensation value based on the current frame input pixel value, the previous frame input pixel value, or both to compensate for the voltage error;
apply the compensation value to the current frame input pixel value to obtain a current frame output pixel value;
output the current frame output pixel value; and
store the current frame output pixel value in memory.

16. The tangible, non-transitory, computer-readable medium of claim 15, wherein the LUT comprises a two-dimensional LUT.

17. The tangible, non-transitory, computer-readable medium of claim 15, wherein determining the compensation value comprises causing the one or more processors to interpolate the LUT via a barycentric-bilinear algorithm.

18. The tangible, non-transitory, computer-readable medium of claim 15, wherein executing the computer-readable instructions causes the electronic device to apply a weighting factor to the compensation value, wherein the weighting factor is based on a spatial position of a plurality of display pixels on the electronic display.

19. The tangible, non-transitory, computer-readable medium of claim 18, wherein the weighting factor is greatest at a first spatial position of the plurality of the display pixels directly above the under-display sensor and decreases as a distance of the spatial position from the under-display sensor increases.

20. The tangible, non-transitory, computer-readable medium of claim 18, wherein the compensation value is based in part on a timing profile comprising one or more time periods for activation of the under-display sensor of the electronic display.
